(19) United States
(12) Patent Application Publication
(10) Pub. No.: US 2018/0288322 A1
(43) Pub. Date: Oct. 4, 2018

(54) IMAGE-CAPTURING APPARATUS AND IMAGE-CAPTURING CONTROL METHOD

(71) Applicant: CANON KABUSHIKI KAISHA, Tokyo (JP)

(72) Inventor: Akihiko Masuki, Kawasaki-shi (JP)

(21) Appl. No.: 15/935,216

(22) Filed: Mar. 26, 2018

(30) Foreign Application Priority Data
Mar. 30, 2017 (JP) 2017-066488

(51) Int. Cl. H04N 5/232; G02B 7/10; H04N 5/238; H04N 5/225; H04N 5/235; G06T 11/60

(52) U.S. Cl. CPC H04N 5/23238; G02B 7/10; H04N 5/23296; H04N 5/238; G06T 2207/30232; H04N 5/2355; G06T 11/60; G06T 2207/10016; G06T 2207/20212; H04N 5/2259

(57) ABSTRACT

The image-capturing apparatus includes an image-capturing device configured to perform image capturing through multiple magnification-variable optical systems to acquire multiple images to be continuously joined together, and a controller configured to control magnification-varying operations of the respective magnification-variable optical systems. The controller is configured to, when a first magnification-variable optical system of the multiple magnification-variable optical systems performs the magnification-varying operation to a telephoto side, cause a second magnification-variable optical system thereof to perform the magnification-varying operation to a wide-angle side.

### BACKGROUND OF THE INVENTION

### Field of the Invention

The present invention relates to an image-capturing apparatus performing wide-field-angle image capturing such as omnidirectional image capturing and panorama image capturing.

### Description of the Related Art

As a method of performing the wide-field-angle image capturing, a method is known that joins together multiple captured images acquired by multiple cameras to produce a continuous single image.

When the wide-field-angle image capturing is performed for monitoring in order to prevent crimes or the like, a specific object image is often enlarged from the captured image and observed in detail. Conventionally, in such a case, part of the captured image is clipped out and enlarged by electronic zoom. However, the electronic zoom has a problem that degrades image quality.

Japanese Patent Laid-Open No. 2015-194901 discloses an image-capturing system including two cameras that are a wide-angle camera capable of capturing an almost entire monitored area and a movable camera including a camera platform mechanism and capable of changing its image-capturing direction and its zoom magnification ratio in response to external signals. This image-capturing system specifies, from a wide-field image acquired by the wide-angle camera, a position of an object that is a tracked target, and controls the image-capturing direction and the zoom magnification ratio such that a high-resolution object tracking image can be acquired.

However, the image-capturing system disclosed in Japanese Patent Laid-Open No. 2015-194901 uses the wide-angle camera and the movable camera disposed away from each other, and therefore cannot acquire a wide-field image and an enlarged image of a specific object by a single camera.

### SUMMARY OF THE INVENTION

The present invention provides an image-capturing apparatus capable of simultaneously acquiring, by a single camera, a wide-field image and a high-quality enlarged image of an object included in the wide-field image.

The present invention provides as an aspect thereof an image-capturing apparatus including an image-capturing device configured to perform image capturing through multiple magnification-variable optical systems to acquire multiple images to be continuously joined together, and a controller configured to control magnification-varying operations of the respective magnification-variable optical systems. The controller is configured to, when a first magnification-variable optical system of the multiple magnification-variable optical systems performs the magnification-varying operation to a telephoto side, cause a second magnification-variable optical system thereof to perform the magnification-varying operation to a wide-angle side.

The present invention provides as another aspect thereof an image-capturing control method including a step of performing image capturing through multiple magnification-variable optical systems to acquire multiple images to be continuously joined together, and a control step of controlling magnification-varying operations of the respective magnification-variable optical systems. The control step causes, when a first magnification-variable optical system of the multiple magnification-variable optical systems performs the magnification-varying operation to a telephoto side, a second magnification-variable optical system thereof to perform the magnification-varying operation to a wide-angle side.

The present invention provides as yet another aspect thereof a non-transitory storage medium storing a computer program that causes a computer in an image-capturing apparatus, which is configured to perform image capturing through multiple magnification-variable optical systems to acquire multiple images to be continuously joined together, to perform a control process according to the above control method.

The present invention provides as yet another aspect thereof an image-capturing apparatus including a main body of the apparatus, multiple image-capturing devices provided in the main body such that their optical axes mutually intersect at one point and each configured to be capable of performing an optical zoom operation, and a controller configured to control the optical zoom operations of the image-capturing devices. The image-capturing devices are configured to perform image capturing for acquiring an omnidirectional image by partially overlapping their field angles. The controller is configured to, when a first image-capturing device of the multiple image-capturing devices performs image capturing with the optical zoom operation to a telephoto side for acquiring an enlarged image of a specific object, cause a second image-capturing device of the multiple image-capturing devices to perform the optical zoom operation to a wide-angle side so as to generate no field angle lack between the first and second image-capturing devices, thereby maintaining the image capturing for acquiring the omnidirectional image by the multiple image-capturing devices.

Further features of the present invention will become apparent from the following description of exemplary embodiments with reference to the attached drawings.

### BRIEF DESCRIPTION OF THE DRAWINGS

FIG. 1 is an external perspective view of an omnidirectional camera that is an embodiment of the present invention.

FIG. 2 is a perspective view of a lens barrel in the embodiment.

FIG. 3 is an exploded perspective view of the lens barrel in the embodiment.

FIG. 4 is an exploded perspective view of a second lens holding barrel in the embodiment.

FIG. 5 is a front view of the second lens holding barrel in the embodiment.

FIG. 6 is a sectional view of the lens barrel at a retracted position in the embodiment.

FIG. 7 is a sectional view of the lens barrel at a WIDE position in the embodiment.

FIG. 8 is a sectional view of the lens barrel at a TELE position in the embodiment.

FIG. 9 is a perspective view of a state where a tripod of the camera of the embodiment is extended.

FIG. 10 is a perspective view of an activated state of the camera of the embodiment.

FIG. 11 is a conceptual diagram of a field angle allocation in the embodiment.

FIGS. 12A and 12B respectively illustrate horizontal and vertical field angles in the activated state in this embodiment.

FIGS. 13A and 13B respectively illustrate horizontal and vertical field angles in a telephoto state in this embodiment.

FIG. 14 is a conceptual diagram of image capturing during optical zoom in the embodiment.

FIG. 15 illustrates an omnidirectional image acquired by the camera in a wide-angle state in the embodiment.

FIG. 16 illustrates an omnidirectional image acquired by the camera in a telephoto state in the embodiment.

FIG. 17 is a vertical sectional view of the camera in the telephoto state of the embodiment.

FIG. 18 is a block diagram illustrating a configuration of an omnidirectional image-capturing system including the camera of the embodiment.

FIG. 19 is a flowchart illustrating an image-capturing control process performed by the camera of the embodiment when the optical zoom is performed.

FIG. 20 is a flowchart illustrating an image-capturing control process performed by the camera of the embodiment during the optical zoom.

### DESCRIPTION OF THE EMBODIMENTS

Exemplary embodiments of the present invention will hereinafter be described with reference to the accompanying drawings.

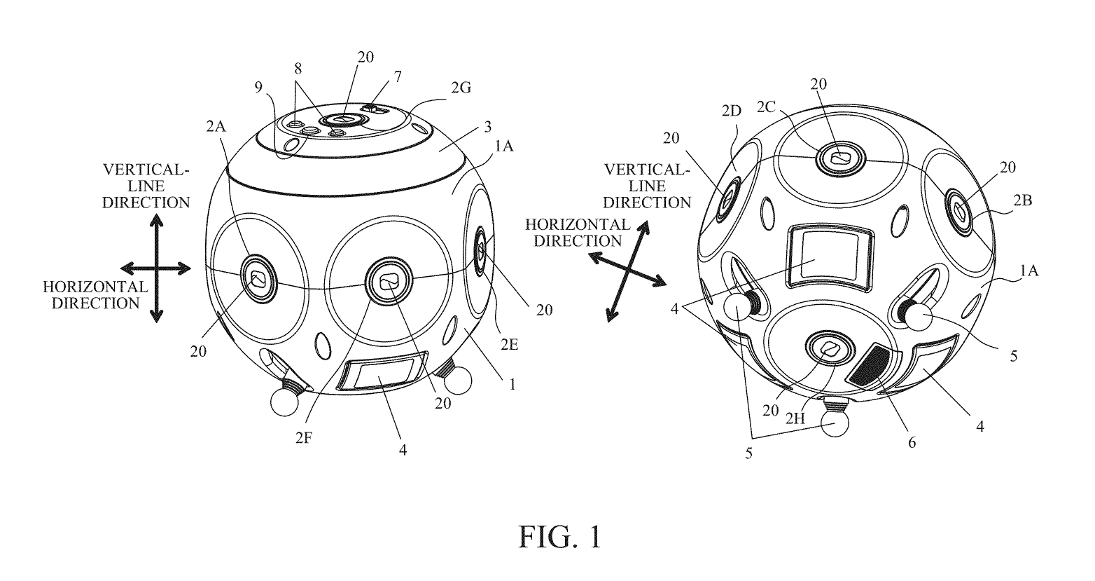

FIG. 1 illustrates an exterior of an omnidirectional camera as an image-capturing apparatus that is an embodiment of the present invention. This omnidirectional camera acquires, by image capturing through multiple image-capturing optical systems that faces toward mutually different directions, multiple images (partial images), and joins the multiple images together to produce an omnidirectional image (joined image) that is a continuous single image of an image-capturing area over horizontal 360 degrees and vertical 360 degrees.

A camera body (main body) 1 has a spherical exterior member 1A. At six horizontal portions and two vertical portions (upper and lower portions) of the camera body 1, lens barrels 2 (2A to 2H) respectively housing image-capturing lenses are held (disposed) such that the image-capturing lenses face toward mutually different directions. Specifically, the lens barrels 2A to 2F face toward mutually different directions in a horizontal plane, and the lens barrels 2G and 2H face upward and downward, that is, toward mutually different directions in a vertical-line direction.

The vertical-line direction is a direction in which a straight line extends along gravity acting on the camera body 1 that is set on a horizontal camera setting plane by using a built-in tripod 5. The vertical-line direction is also called a vertical direction. A plane parallel to the vertical-line direction is called a vertical plane. The horizontal plane is a plane orthogonal to the vertical-line direction. Directions (azimuths) included in this horizontal plane are called horizontal directions. The image-capturing lenses in the eight lens barrels 2 in total are magnification-variable optical systems each capable of performing a magnification-varying (optical zoom) operation for changing its focal length. The magnification-variable optical system corresponds to the image-capturing lens in reality, but in the following description the magnification-variable optical system corresponds to the lens barrel including the image-capturing lens.

At a front end portion of each lens barrel 2, a lens barrier 20 is provided that opens and covers a front face of the image-capturing lens. The lens barrier 20 is opened and shut in interlock with lens barrel operations in response to ON and OFF of a power switch 7 for moving out from and retracting into the camera body 1 between a retracted state illustrated in FIG. 1 and a protruded state at which the lens barrel 2 protrudes from the camera body 1. The power switch 7 is provided in the upper portion of the camera body 1.

Furthermore, between the lens barrel 2 (2G) disposed in the upper portion of the camera body 1 and the six lens barrels 2 (2A to 2F) in the horizontal plane, a ring illuminator 3 that projects illumination light evenly to objects around the camera is provided.

In addition, between the lens barrel 2 (2H) disposed in the lower portion of the camera body 1 and the six lens barrels 2 (2A to 2F) in the horizontal plane, three movable illumination units 4 and the built-in tripod (hereinafter simply referred to as “a tripod”) 5 for stably setting the camera body 1 are provided. The movable illumination units 4 can be retracted into the camera body 1 as illustrated in FIG. 1 and protruded from the camera body 1 to arbitrarily adjusted illumination positions. The tripod 5 can be retracted into the camera body 1 as illustrated in FIG. 1 and has legs whose lengths and angles can be arbitrarily changed so as to allow adjusting height of the camera body 1 from the camera setting plane. The movable illumination units 4 and the tripod 5 that are protruded from the camera body 1 are protruding members.

In the lower portion of the camera body 1, a battery chamber 6 is provided. A battery housed in this battery chamber 6 supplies power to the camera body 1. On the other hand, in the upper portion of the camera body 1, a zoom button 8 is provided for selecting one or more of the eight lens barrels 2 that perform the optical zoom operation and instructing the optical zoom operation, and a release button 9 for causing the camera to start an image-capturing preparation operation (focusing and photometry operations) and an image-capturing operation (that is, exposure of image sensors described later).

The optical zoom operation, the image-capturing preparation operation and the image-capturing operation can be performed in response to remote control through communication from an external instruction device such as a personal computer or a smartphone.

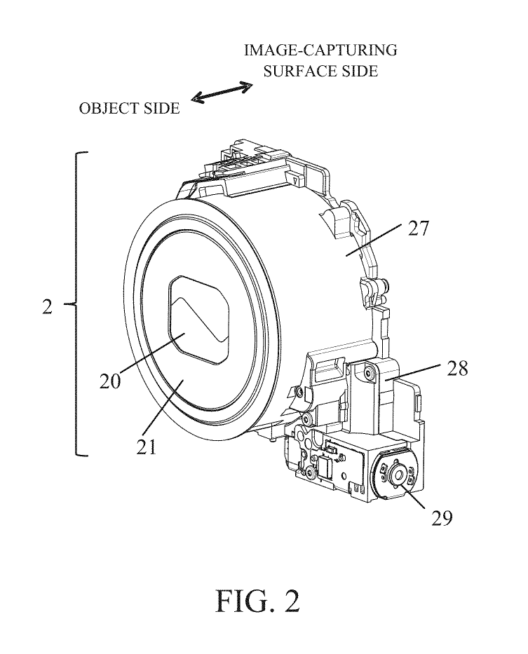

FIG. 2 illustrates one of the eight lens barrels 2 (2A to 2H) provided in the camera body 1. The lens barrel 2 is a retractable lens barrel that is retracted into the camera body 1 in a power-OFF state of the camera and is protruded outside from the camera body 1 for enabling image capturing in a power-ON state. In addition, in the power-OFF state the lens barrier 20 covers the front face of the image-capturing lens as described above, and thereby scratching on the front face and intrusion of dust into the lens barrel 2 are prevented.

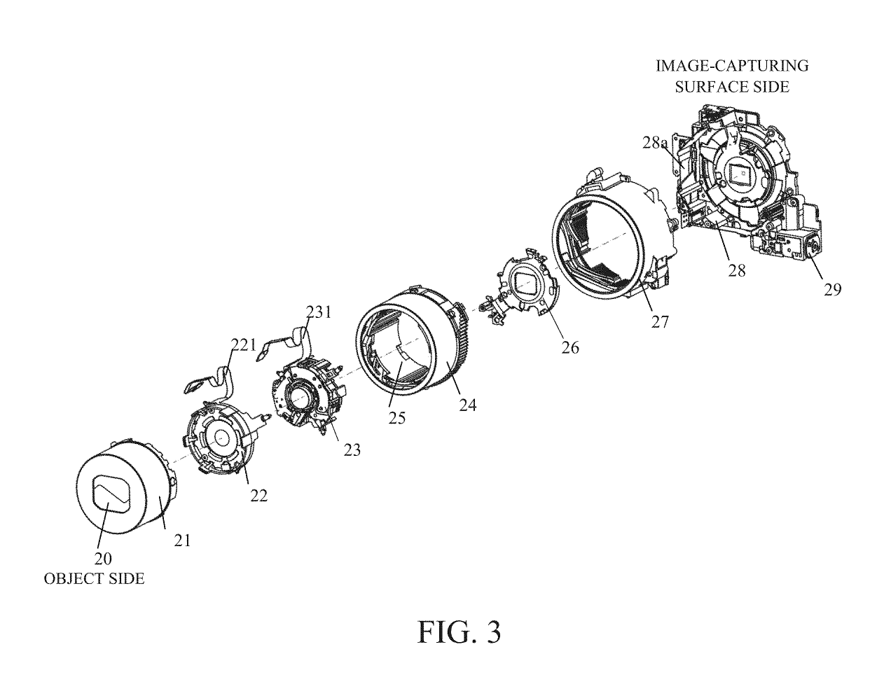

FIG. 3 is an exploded view of the lens barrel 2. The image-capturing lens includes a first lens unit, a second lens unit and a third lens unit that are not illustrated. The first lens unit is held by a first lens holding barrel 21. The above-described lens barrier 20 is provided to the first lens holding barrel 21. An aperture stop 22 controls an amount of light. The second lens unit is held by a second lens holding barrel 23. The second lens holding barrel 23 also holds an image-stabilizing mechanism and a shutter.

A movable cam ring 24 has, in its inner circumferential portion, cam groove portions respectively for moving the first lens holding barrel 21, the aperture stop unit 22 and the second lens holding barrel 23 in a direction in which an optical axis of the lens barrel extends (the direction is hereinafter referred to as “an optical axis direction”). The movable cam ring 24 has, on its outer circumferential portion, a gear portion to which driving force from a drive motor 29 is transmitted. The movable cam ring 24 is held rotatably relative to the first lens holding barrel 21, the aperture stop unit 22, the second lens holding barrel 23, and further to a straight-movable barrel 25 and a stationary (fixed) barrel 27 that will be described later. The movable cam ring 24 receives, at its gear portion, driving force from the drive motor to be rotated thereby. The straight-movable barrel 25 guides the first lens holding barrel 21, the aperture stop unit 22 and the second lens holding barrel 23 in the optical axis direction and prevents rotation thereof about the optical axis. The third lens holding barrel 26 holds the third lens unit. The stationary barrel 27 houses therein the first lens holding barrel 21, the aperture stop unit 22, the second lens holding barrel 23, the movable cam ring 24 and the third lens holding barrel 26 movably in the optical axis direction. The stationary barrel 27 has, in its inner circumferential portion, three cam groove portions for moving the movable cam ring 24 in the optical axis direction.

An image sensor holding unit 28 holds the image sensor (not illustrated). The stationary barrel 27 is fixed to the image sensor holding unit 28. The image sensor holding unit 28 further holds the above-described drive motor 29. A lens barrel flexible wiring board 28a is fixed to the image sensor holding unit 28. The lens barrel flexible wiring board 28a is connected to an aperture stop flexible wiring board 221 connected to a driver of the aperture stop unit 22 and to a second lens unit flexible wiring board 231 connected to a shutter driver of the second lens holding barrel 23, outside the stationary barrel 27.

The above-described configuration of the lens barrel 2 is merely an example. The lens barrel may be a non-retractable lens barrel in which lens units are moved thereinside to perform the optical zoom operation.

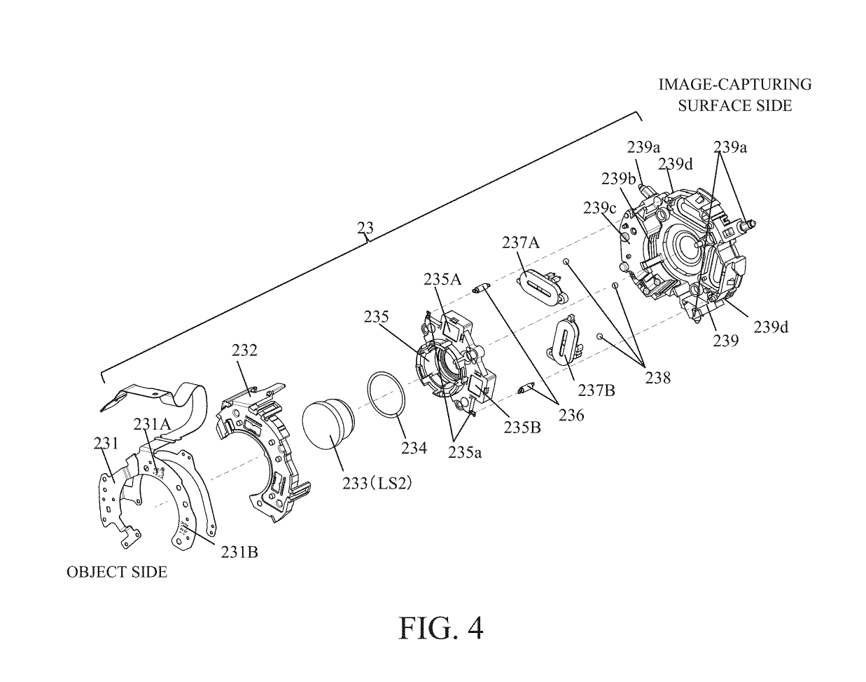

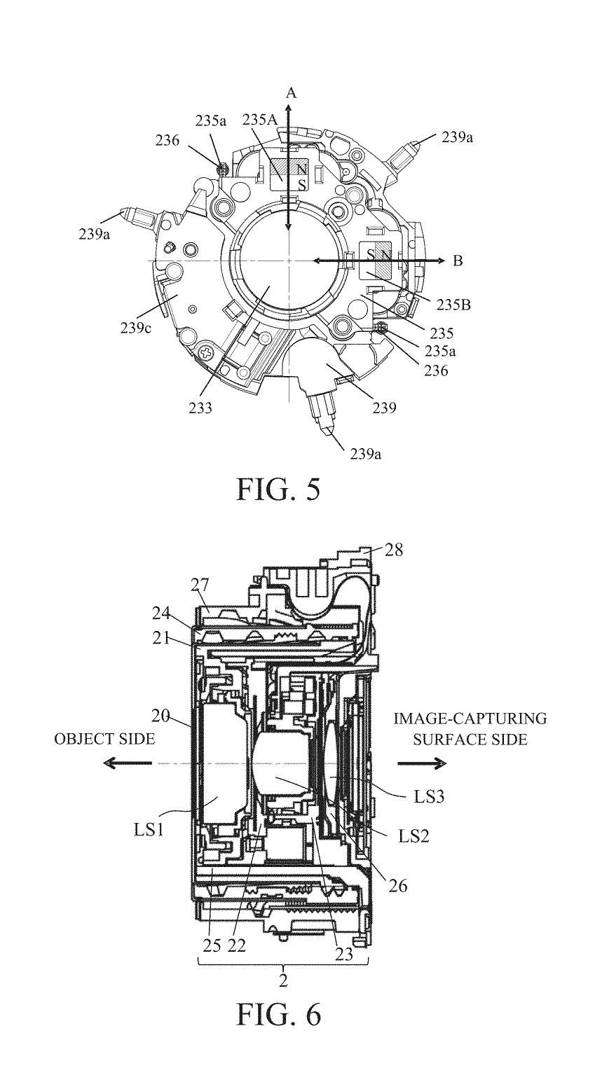

FIG. 4 is an exploded view of the image-stabilizing lens mechanism provided in the second lens holding barrel 23 illustrated in FIG. 3. FIG. 5 illustrates the image-stabilizing lens mechanism (the second lens unit flexible wiring board 231 and a sensor holder 232 described later are omitted) viewed from an object side in the optical axis direction. A second lens unit base 239 serves a base of the second lens holding barrel 23. The second lens unit base 239 has three follower pins 239a engaging with the three cam groove portions of the movable cam ring 24. In a partial area of the second lens unit base 239 in a direction around the optical axis, a shutter yoke 239b is fixed. A cover member 239c covering the shutter yoke 239b from the object side is fixed to the second lens unit base 239. The shutter yoke 239b and a rotor (not illustrated) constitute a shutter actuator. The shutter actuator is a two-position-switching actuator whose arm provided to the rotor stops at two different positions depending on an energization direction of the shutter actuator.

A second lens unit holder 235 holds a second lens unit 233 (LS2) fixed thereto using adhesive or the like together with a mask member 234 for cutting unwanted light. The second lens unit holder 235 holds magnets 235A and 235B. In the following description, characters A and B added to reference numerals respectively correspond to an A-direction (pitch direction) and a B-direction (yaw direction) illustrated in FIG. 5. A magnet 235A whose N- and S-poles are arranged in the A-direction and a magnet 235B whose N- and S-poles arranged in the B-direction are held by the second lens unit holder 235. At two portions of the second lens unit holder 235, hooks 235a are provided. On these hooks 235a, one ends of tension springs 236 are hooked.

Coil units 237A and 237B each include a coil and a bobbin. The coil units 237A and 237B are fixed using adhesive or the like in concave portions formed in the second lens unit base 239 at positions that face the magnets 235A and 235B in the optical axis direction and are different from positions of the shutter yokes 239b in the second lens unit base 239. The coils provided in the bobbins are energized by connecting the second lens unit flexible wiring board 231 to terminals of the coils.

Other ends of the springs 236 whose one ends are hooked on the second lens unit holder 235 are hooked on hooks 239d of the second lens unit base 239. Between the second lens unit base 239 and the second lens unit holder 235, three non-magnetic balls 238 are sandwiched. The springs 236 bias the second lens unit holder 235 toward the second lens unit base 239 in the optical axis direction. Thereby, the second lens unit holder 235 is pressed to the second lens unit base 239 via the balls 238 in the optical axis direction. The second lens unit holder 235 can be smoothly moved (shifted) in a plane orthogonal to the optical axis by rolling the balls 238. Shifting the second lens unit holder 235 depending on camera shakes due to hand jiggling or the like in the above-described plane enables performing image-stabilizing control for reducing image blur on the image sensor.

The sensor holder 232 is fixed to the second lens unit base 239 so as to cover the magnets 235A and 235B of the second lens unit holder 235 and therearound from the object side. The sensor holder 232 positions and holds hall elements 231A and 231B described later.

The second lens unit flexible wiring board 231 is connected to the above-described coil units 237A and 237B and to a shutter actuator. On the second lens unit flexible wiring board 231, the hall elements 231A and 231B are mounted. Detecting changes of magnetic fields from the magnets 235A and 235B shifting with the second lens unit holder 235 through the hall elements 231A and 231B enables detecting a movement amount of the second lens unit holder 235 from its neutral position on the optical axis, that is, a position of the second lens unit holder 235. Thereby, the image-stabilizing control can perform feedback control of the position of the second lens unit holder 235.

FIG. 6 illustrates a section of the lens barrel 2 in its retracted state (at its retracted position). In the retracted state, the first, second and third lens units LS1, LS2 and LS3 are arranged so as to minimize distances therebetween, and the lens barrier 20 is shut.

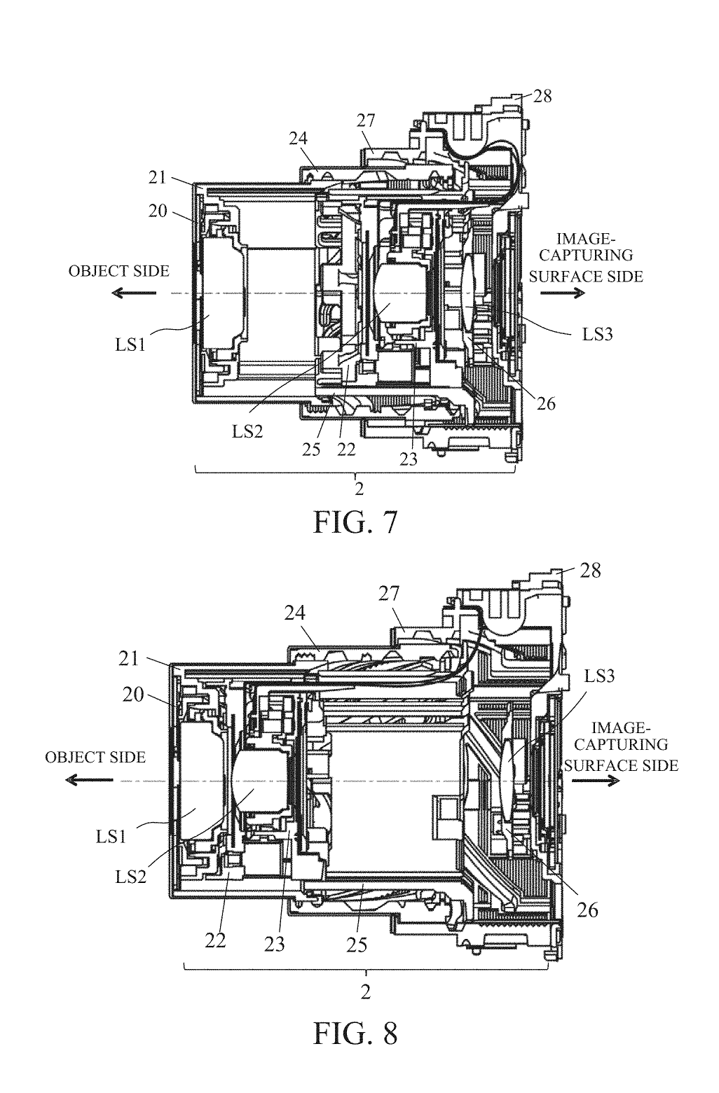

FIG. 7 is a section of the lens barrel 2 in its wide-angle end state (at a WIDE position). Driving the drive motor 29 from the retracted state moves the first lens holding barrel 21 and the movable cam ring 24 outward such that they protrude from the stationary barrel 27 (camera body 1) and arranges the first, second and third lens units LS1, LS2 and LS3 at positions illustrated in FIG. 7, thereby enabling image capturing at the WIDE position. At the WIDE position, the lens barrel 2 has a maximum field angle, and an image area acquired by one lens barrel 2 is widest in an omnidirectional image described later.

FIG. 8 is a section of the lens barrel 2 in its telephoto end state (at a TELE position). Driving the drive motor 29 from the wide-angle state moves the first lens holding barrel 21 and the movable cam ring 24 relative to the stationary barrel 27 further outward than the wide-angle end state and arranges the first, second and third lens units LS1, LS2 and LS3 at positions illustrated in FIG. 8. At the TELE position, the lens barrel 2 has a minimum field angle, and an image area acquired by one lens barrel 2 is narrowest in the omnidirectional image.

Although this embodiment describes the case of using the lens barrels whose magnification-variable optical system includes the three lens units, the number of lens units may be other than three.

When, of the omnidirectional image, an image area including a specific object is required to be enlarged, performing a telephoto side optical zoom operation (that is, an optical zoom operation to a telephoto side) of the lens barrel 2 capturing the specific object enables projecting an enlarged optical image of the specific object onto the image sensor. This makes it possible to provide an enlarged object image whose image quality is not deteriorated by electronic zoom. Each of the eight lens barrels 2 provided in the camera can continuously change its field angle in a range from the wide-angle end state to the telephoto end state.

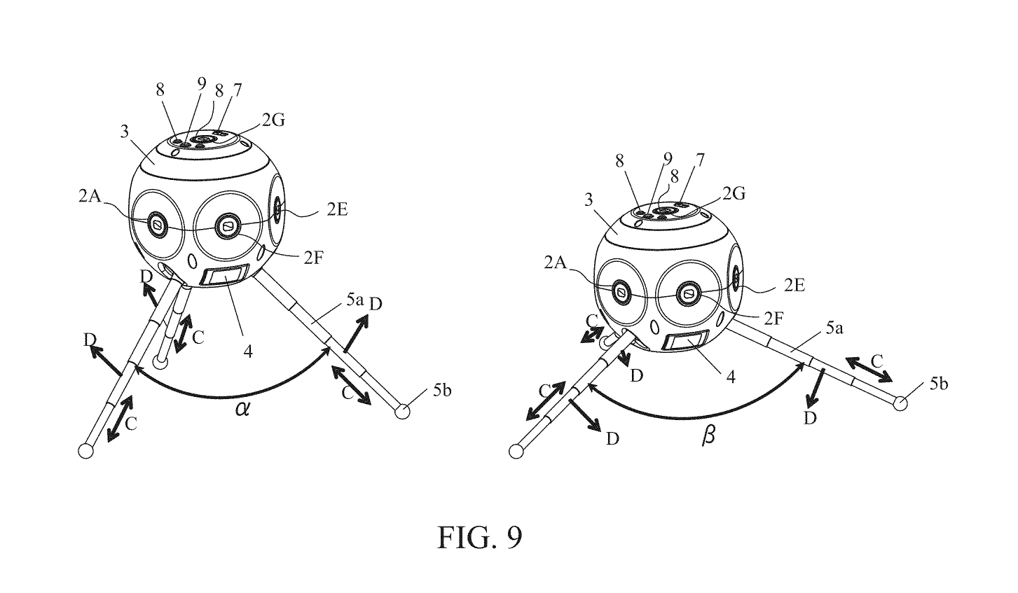

FIG. 9 illustrates a case where, as a preparation of image capturing, a user manually extends the legs 5a of the tripod 5 and sets the camera on the camera setting plane. The three legs 5a of the tripod 5 are extended in a C-direction from the retracted state illustrated in FIG. 1, and three ground contact portions 5b supports the camera body 1. The angles between the three legs 5a can be changed from α to β in a D-direction, and the legs 5a can be extended and contracted, so that their combination enables adjusting the height of the camera body 1.

The camera body 1 includes thereinside a mechanism for equalizing the angles of the three legs 5a relative to the vertical-line direction. The mechanism enables, if the camera setting plane is horizontal, causing the lens barrels 2A to 2F to accurately face to the horizontal directions and causing the lens barrels 2G and 2H to respectively accurately face to an upper side (sky side) and to a lower side (ground side).

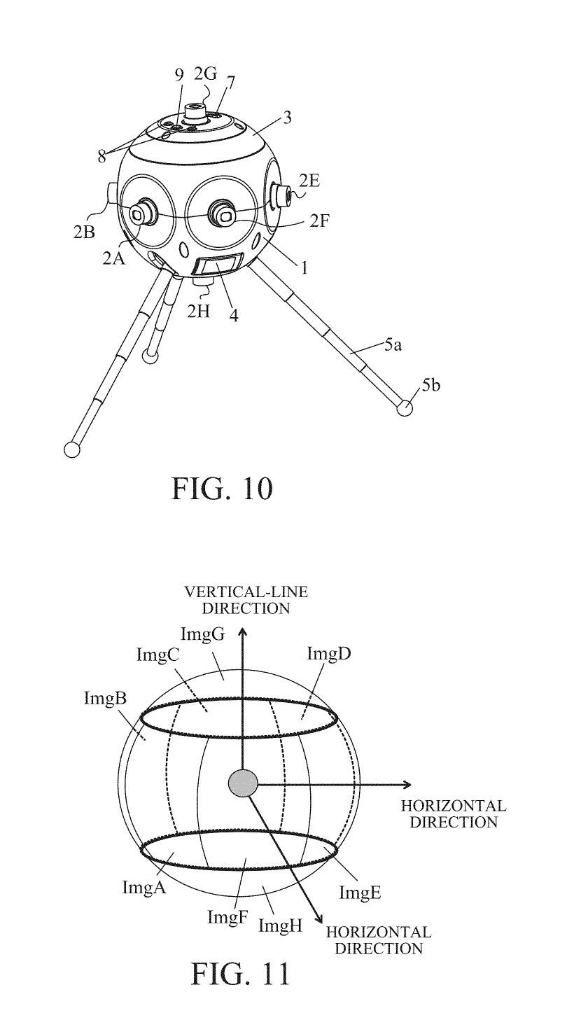

FIG. 10 illustrates the power-ON state where the camera is activated in response to a user's ON-operation of the power switch 7 provided in the upper portion of the camera body 1. In the power-ON state, all the lens barrels 2 (2A to 2H) are moved out from the power-OFF state, and the lens barriers 20 are opened, thereby allowing image capturing. In this state, field angles of the eight lens barrels 2 are set such that image capturing of omnidirectional directions including the horizontal 360° directions and sky and ground directions can be performed.

FIG. 11 illustrates an allocation of image areas (hereinafter referred to as “partial images”) for the eight lens barrels 2A to 2H in the omnidirectional image as a captured image acquired by the omnidirectional image capturing. The partial images acquired by the lens barrels 2A to 2F in the horizontal 360° directions are denoted by ImgA to ImgF. The partial images acquired by the sky-side lens barrels 2G and the ground-side lens barrel 2H are denoted by ImgG and ImgH.

Border lines between the partial images are stitched portions in which mutually adjacent partial images are stitched (joined) together in order to produce one continuous omnidirectional image. The camera of this embodiment acquires, through each of the lens barrels 2A to 2H, an image larger than the partial image. Then, the camera detects, from peripheral areas larger than the partial images in two of the acquired eight images, feature points common to the two acquired images, and stitches the two acquired images together such that the feature points overlap each other. Thus, partial images stitched so as to include no object position differences are produced. Performing such a stitching process on all the acquired images produces the omnidirectional image.

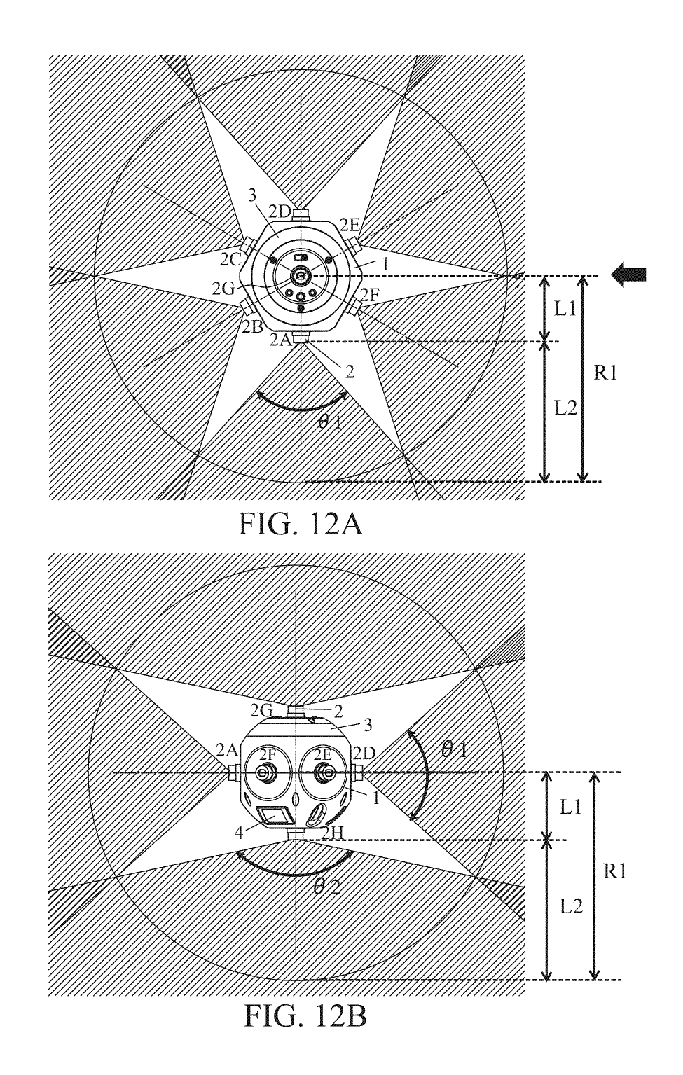

FIG. 12A illustrates horizontal field angles of the lens barrels 2 (2A to 2F) in the horizontal plane when the camera body 1 is viewed from its upper side.

The horizontal field angles of the six lens barrels 2A to 2F arranged at circumferential equal angular intervals are all θ1. The omnidirectional image capturing of a horizontal continuous 360° field angle can be performed in a further outside area than a circle whose radius is R1, the area in which parts of the field angles of the circumferentially mutually adjacent lens barrels 2 overlap one another. R1 corresponds to a distance from a center of the camera body 1 (an optical axis position of the lens barrel 2G) to a position at which the omnidirectional image capturing of the continuous 360° field angle can be performed. L1 represents a distance from the center of the camera body 1 to front ends of the lens barrels 2A to 2F. L2 represents an omnidirectional image-capturing closest distance obtained by subtracting L1 from R1, that is, a closest image-capturing distance at which no discontinuity is generated between the field angles of the lens barrels 2A to 2F.

In this embodiment, description will be made of the field angle of each lens barrel 2, not as a quadrangular pyramid field angle corresponding to short and long sides and diagonal corners of the image sensor, but as a simple conic field angle. Furthermore, in this embodiment, though a moving-out amount of the lens barrel 2 changes depending on its optical zoom position, an amount of the change is sufficiently smaller than the omnidirectional image capturing closest distance L2 and therefore is ignorable, so that regardless of the optical zoom position the distance from the center of the camera body 1 to the front ends of the lens barrels 2A to 2F is defined as L1.

FIG. 12B illustrates vertical field angles of the lens barrels 2A, 2D, 2G and 2H in the vertical plane when the camera body 1 is viewed from the horizontal direction (that is, an arrow direction in FIG. 12A) in the state illustrated in FIG. 12A. The vertical field angles of the lens barrels 2A and 2D are θ1. On the other hand, the vertical field angles of the lens barrels 2G and 2H are θ2 (>θ1). The omnidirectional image capturing of a vertically continuous 360° field angle can be performed in a further outside area than a circle whose radius is R1, the area in which parts of the field angles of the lens barrels 2A, 2D, 2G and 2H overlap one another.

In order to obtain an omnidirectional image-capturing closest distance L2 as with the case of FIG. 12A, it is necessary to set a distance from the center of the camera body 1 to a position at which the omnidirectional image capturing of the continuous 360° field angle can be performed to R1. However, the number of the lens barrels 2G and 2H used for the omnidirectional image capturing in the vertical plane is smaller than that in the horizontal plane, so that the field angles of these lens barrels 2G and 2H are set to θ2 larger than θ1. When the camera is activated, the camera sets, for example, the field angles θ1 of the lens barrels 2A to 2F and the field angles θ2 of the lens barrels 2G and 2H such that a minimum omnidirectional image-capturing closest distance L2 is obtained. However, when the camera is activated, the camera may set narrower field angles θ1 and θ2 such that a longer omnidirectional image-capturing closest distance L2 is obtained.

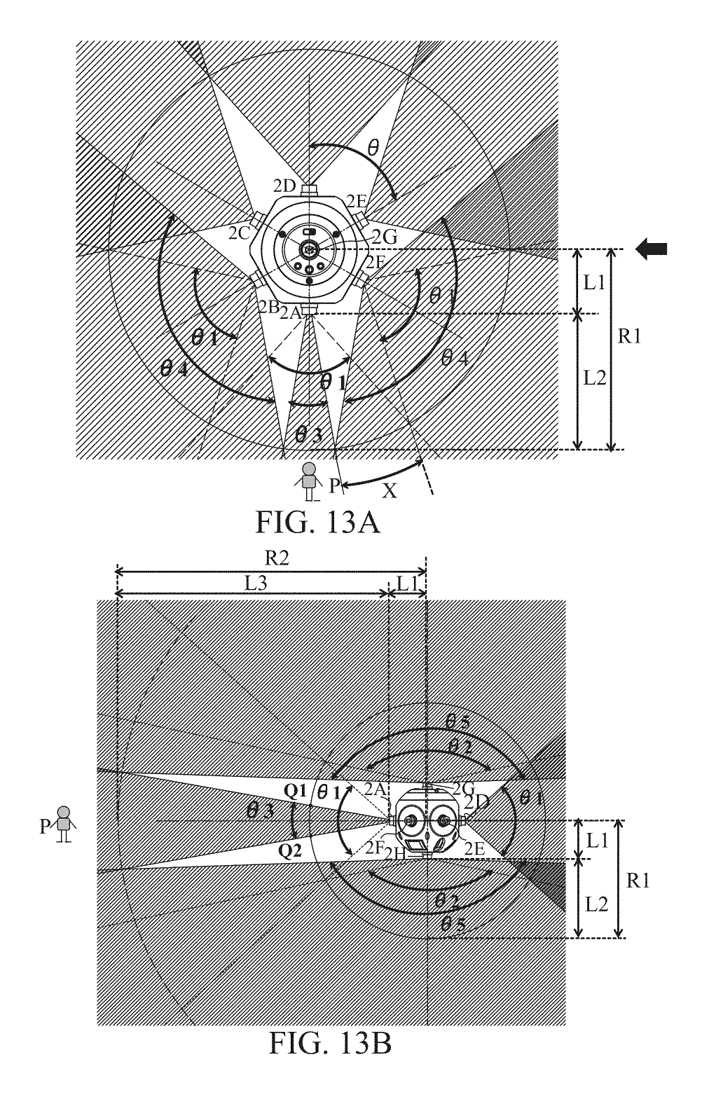

FIG. 13A illustrates the camera body 1 in which only the lens barrel (first magnification-variable optical system) 2A performs, from the state illustrated in FIGS. 12A and 12B, a telephoto-side optical zoom (magnification-varying) operation so as to enlarge a specific object P when the camera is viewed from its upper side. The field angle of the lens barrel 2A is narrowed from θ1 illustrated by broken lines to θ3 (<θ1). Therefore, if the field angles of the lens barrels 2B and 2F adjacent on both sides to the lens barrel 2A are maintained at θ1 illustrated by the broken lines, parts of their field angles do not overlap the field angle of the lens barrel 2A, so that the omnidirectional image capturing of the continuous 360° field angle cannot be performed.

Thus, the camera of this embodiment controls so as to widen the field angles of the lens barrels 2B and 2F acquiring the partial images joined to the partial image acquired through the lens barrel 2A from θ1 to a wider field angle θ4 (>θ1). That is, the camera causes the lens barrels (second magnification-variable optical systems) 2B and 2F to perform a wide-angle-side optical zoom operation. This enables overlapping the parts of the field angles of the lens barrels 2B and 2F with the narrowed field angle of the lens barrel 2A, and thereby the omnidirectional image capturing of the continuous 360° field angle can be performed. In this control, it is desirable that the field angle θ4 of each of the lens barrels 2B and 2F be calculated and set such that the same omnidirectional image-capturing closest distance L2 (that is, the distance R1) as that before the change of the field angle of the lens barrel 2A be maintained.

On the other hand, the field angles of the other lens barrels 2C to 2E in the horizontal plane are not changed, so that an overlap area of the field angles of the lens barrels 2B and 2C and an overlap area of the field angles of the lens barrels 2E and 2F are increased. Therefore, the omnidirectional image-capturing closest distance near those lens barrels is reduced from L2. In this case, the camera may notify the user that its omnidirectional image-capturing area includes a part where the omnidirectional image-capturing closest distance L2 is shorter than those of other parts, or may enlarge a detection area where the feature points are detected in the stitching process.

FIG. 13B illustrates field angles of the lens barrels 2A, 2D, 2G and 2H in the vertical plane when the camera body 1 is viewed from the horizontal direction (that is, an arrow direction in FIG. 13A) in the state illustrated in FIG. 13A. As in FIG. 13A, the field angle of the lens barrel 2A is narrowed from θ1 illustrated by dotted lines to θ3 (<θ1). Therefore, if the field angles of the lens barrels 2G and 2H adjacent on both sides in the sky and ground directions to the lens barrel 2A are maintained at θ2 illustrated by dotted lines, parts of their field angles do not overlap the field angle of the lens barrel 2A, so that the omnidirectional image capturing of the continuous 360° field angle cannot be performed.

Thus, the camera of this embodiment controls such that the field angles of the lens barrels 2G and 2H widens from θ2 to a wider field angle θ5 (>θ2). This enables overlapping the parts of the field angles of the lens barrels 2G and 2H with the narrowed field angle of the lens barrel 2A, and thereby the omnidirectional image capturing of the continuous 360° field angle can be performed.

In this control, it is desirable that, as described with reference to FIG. 13A, the field angle θ5 of each of the lens barrels 2G and 2H be calculated and set such that the same omnidirectional image-capturing closest distance L2 (that is, the distance R1) as that before the change of the field angle of the lens barrel 2A be maintained. In other words, it is desirable that the field angle θ5 be set so as to pass through Q1 and Q2 in FIG. 13B. However, when it is impossible to set such wide field angles of the lens barrels 2G and 2H even though they are in the wide-angle end state, as illustrated in FIG. 13B, it is necessary to change the omnidirectional image-capturing closest distance from L2 to L3 (that is, to the distance R2) at which the omnidirectional image capturing using the field angle θ5 can be performed. In this case, it is desirable to notify the user that the omnidirectional image capturing cannot be performed at the preset omnidirectional image-capturing closest distance L2 and that the omnidirectional image-capturing closest distance is changed from L2 to L3 (>L2).

As described above, when the numbers of the lens barrels 2 for performing the omnidirectional image capturing in the horizontal plane and in the vertical plane are different from each other, the lens barrels arranged in the horizontal plane and the sky- and ground-side lens barrels may have mutually different focal lengths or zoom magnification ratios.

Furthermore, when the lens barrel has a super-wide-angle image-capturing lens whose field angle is larger than 180°, since light rays may be blocked by the camera body 1, it is desirable to move the lens barrel out to the object side as described in this embodiment.

As described above, when performing the telephoto-side optical zoom operation of, for example, the lens barrel 2A among the eight lens barrels 2, performing the wide-angle-side optical zoom operation of the lens barrels 2B, 2F, 2G and 2H adjacent to the lens barrel 2A enables performing the omnidirectional image capturing of the horizontally and vertically continuous 360° field angles. However, there are conditions between an arrangement angle of the lens barrels and their field angles for enabling performing the omnidirectional image capturing.

In FIG. 13A, an equal arrangement angle between mutually adjacent two of the lens barrels 2A to 2F (that is, an angle between the optical axes of the mutually adjacent two lens barrels 2) in the horizontal plane is denoted by θ. If the field angle θ3 of the lens barrel 2A does not overlap the field angle θ1 of the lens barrel 2F at all even at an infinite distance, the omnidirectional image capturing of the continuous 360° field angle cannot be performed. The reason for no overlap of these field angles θ3 and θ1 is that an angle X between a line of an end of a half field angle θ3/2 of the lens barrel 2A and a line of an end of a half field angle θ1/2 of the lens barrel 2F is more than 0 such that these lines are spread than mutually parallel lines. Therefore, a smaller angle X than 0 is a condition for overlap of parts of the field angles of the mutually adjacent lens barrels. The angle X is obtained by subtracting, from the above-described arrangement angle θ, a sum of the half field angle θ3/2 of the lens barrel 2A and the half field angle θ1/2 of the lens barrel 2F. That is, the following relations are established.

X=θ−(θ3/2+θ1/2)<0

θ<θ3/2+θ1/2 (1)

In above expression (1), θ3 corresponds to a field angle θ₁ of the first magnification-variable optical system, and θ1 corresponds to a field angle θ₂ of the second magnification-variable optical system.

As described above, the camera of this embodiment compensates for the narrowed field angle of the lens barrel performing the telephoto-side optical zoom operation with the widened field angle of the lens barrel adjacent thereto performing the wide-angle-side optical zoom operation. This compensation requires satisfying the condition that the sum of the half field angles of these mutually adjacent lens barrels is larger than at least the arrangement angle of these lens barrels. The condition of expression (1) is a condition for performing the continuous omnidirectional image capturing at the infinite distance. Therefore, when the omnidirectional image-capturing closest distance is set shorter than the infinite distance as described above, it is necessary to increase the sum of the half field angles so as to increase an overlap amount of the field angles of the lens barrels. Furthermore, at any omnidirectional image-capturing closest distance, the stitching process on the partial images acquired through the mutually separate lens barrels is required, so that it is desirable to perform image capturing at a further widened field angle for obtaining a wider stitching area in the acquired image.

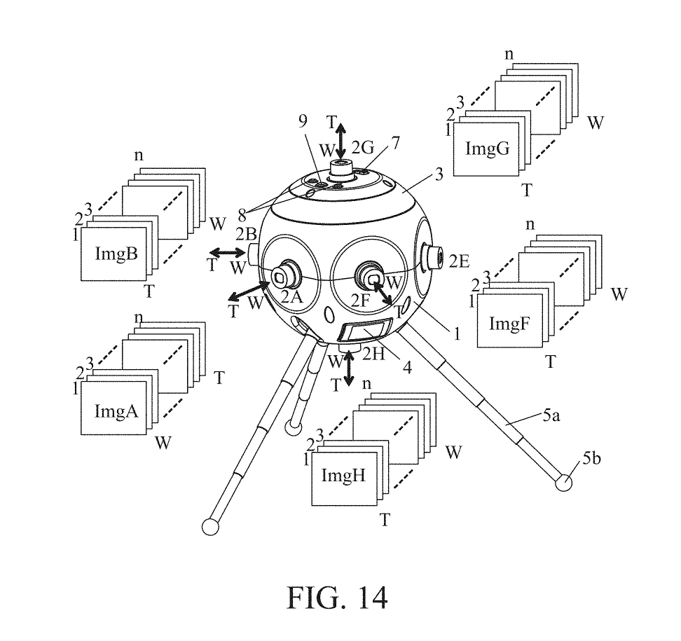

In this embodiment, using the optical zoom operation of any of the lens barrels 2 enables simultaneously acquiring the omnidirectional image and the enlarged image of the specific object. The omnidirectional image is acquired as a continuous image through the multiple lens barrels 2 mutually compensating for their field angles, so that even though positions of the stitching portions are changed, the omnidirectional image is displayed on a monitor without change. However, due to the telephoto-side optical zoom operation of a certain lens barrel, an enlarged image of a specific object is suddenly displayed in the omnidirectional image, which provides a feeling of strangeness to a viewer of the omnidirectional image. Thus, as illustrated in FIG. 14, the camera of this embodiment continuously acquires partial images during the variation of magnification (optical zoom operations) of the lens barrels 2.

The following description will be made of the case where, as described with reference to FIGS. 13A and 13B, the lens barrel 2A performs the telephoto-side optical zoom operation and the lens barrels 2B, 2F, 2G and 2H perform the wide-angle-side optical zoom operations.

In FIG. 14, W written near the respective lens barrels denotes the wide-angle side, and T denotes the telephoto side.

When the telephoto-side optical zoom operation of the lens barrel 2A is performed from the power-ON (activated) state of the camera, simultaneously therewith the wide-angle-side optical zoom operations of the lens barrels 2B, 2F, 2G and 2H are performed so as to satisfy the above-described omnidirectional image-capturing closest distance.

From this start time of the optical zoom operations, the omnidirectional image capturing through the lens barrels 2 is started. Then, multiple partial images ImgA(1 to n) through the lens barrel 2A during its telephoto-side optical zoom operation from the wide-angle side are sequentially acquired. On the other hand, multiple partial images ImgB(1 to n), ImgF(1 to n), ImgG(1 to n) and ImgH(1 to n) through the lens barrels 2B, 2F, 2G and 2H during their wide-angle-side optical zoom operations from the telephoto side are sequentially acquired. Then, the camera stitches (joins) first partial images acquired through the lens barrels 2B, 2F, 2G and 2H performing the optical zoom operations to the partial images acquired through the lens barrels 2C to 2E not performing the optical zoom operations to produce a first omnidirectional image.

The reason for the lens barrels 2C to 2E to perform no optical zoom operations is that the lens barrels 2B, 2F, 2G and 2H perform the wide-angle-side optical zoom operations, that is, the optical zoom operations in a direction in which the overlap areas with the field angles of the lens barrels 2C to 2E increase. Similarly, until the optical zoom operation of the lens barrel 2A is ended, the camera acquires n partial images through each of the lens barrels 2A, 2B, 2F, 2G and 2H to produce n omnidirectional images.

The camera sequentially displays the n omnidirectional images thus acquired on the monitor, which enables displaying a high-quality enlarged image of the specific object so as to smoothly enlarge the enlarged image (that is, so as not to provide the feeling of strangeness to the viewer). Furthermore, enlarged images of other objects existing around the specific object gradually change, so that an omnidirectional image providing little feeling of strangeness.

Although this embodiment described the example in which only one lens barrel performs the telephoto-side optical zoom operation, there is a case where no specific object is set in acquiring the omnidirectional image. Next, description will be made of a case where all the lens barrels perform the telephoto-side optical zoom operations from the wide-angle side. This embodiment in this case enables acquiring eight enlarged images through the eight lens barrels 2A to 2H.

In this case, the camera may cause the eight lens barrels 2A to 2H to one by one perform the telephoto-side optical zoom operations from the wide-angle side to acquire the eight enlarged images corresponding to the eight lens barrels 2A to 2H. However, the camera performs the telephoto-side optical zoom operations of the lens barrels 2A, 2C and 2E in the horizontal plane, and simultaneously therewith performs the wide-angle-side optical zoom operations of the other lens barrels 2B, 2D, 2F, 2G and 2H. Thereby, the camera can acquire enlarged images through the lens barrels 2A, 2C and 2E at once.

Furthermore, the camera performs the telephoto-side optical zoom operations of the lens barrels 2B, 2D and 2F, and simultaneously therewith performs the wide-angle-side optical zoom operations of the lens barrels 2A, 2C, 2E, 2G and 2H. Thereby, the camera can acquire enlarged images through the lens barrels 2B, 2D and 2F at once. Moreover, the camera performs the telephoto-side optical zoom operations of the lens barrels 2G and 2H, and simultaneously therewith performs the wide-angle-side optical zoom operations of the lens barrels 2A to 2F. Thereby, the camera can acquire enlarged images through the lens barrels 2G and 2H at once.

Performing such simultaneous optical zoom operations of the multiple lens barrels 2 enables acquiring the enlarged images through all the lens barrels with a smaller number of times of image capturing and in a shorter time, and enables reducing an amount of image data, compared with a case of performing one by one the optical zoom operations of the lens barrels.

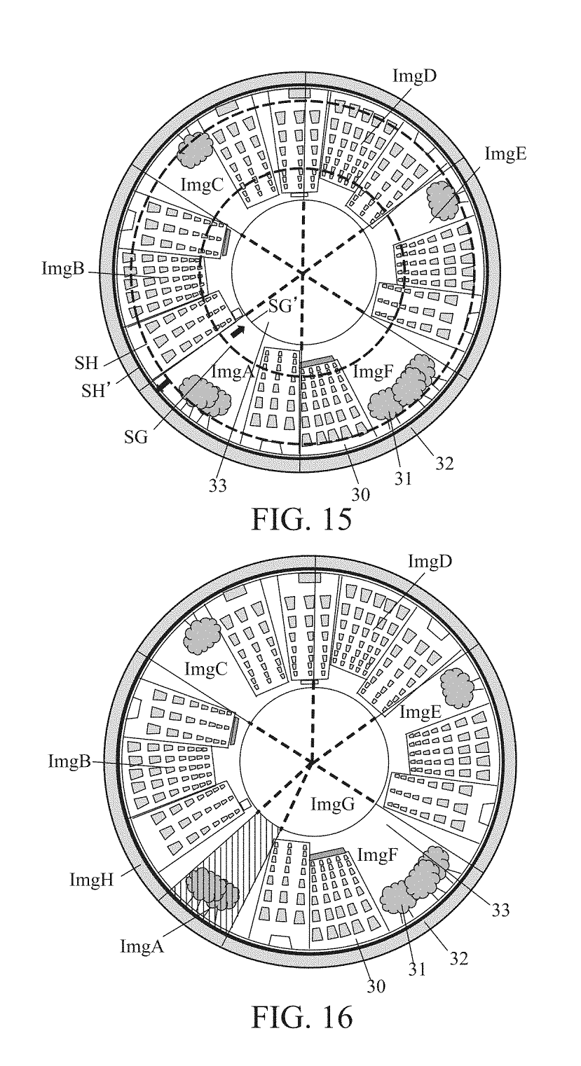

FIG. 15 illustrates an image of landscape of skyscrapers as an example of the omnidirectional image acquired by the omnidirectional image capturing performed by the camera illustrated in FIG. 10. This image includes skyscrapers 30, trees 31, the ground 32 and the sky 33.

A broken line SG denotes stitched portions of a partial image (image inside the broken line SG) acquired through the sky-side lens barrel 2G and partial images (images outside the broken line SG) acquired through the lens barrels 2A to 2F in the horizontal plane.

A broken line SH denotes stitched portions of a partial image (image outside the broken line SH) acquired through the ground-side lens barrel 2H and partial images (images inside the broken line SH) acquired through the lens barrels 2A to 2F in the horizontal plane.

In such an omnidirectional image, the stitched portions SG and SH overlap objects such as the skyscrapers 30 and trees 31. Widows of the skyscrapers 30 are objects having mutually equal shapes and being continuously repeated, so that the camera may erroneously detect feature points. This results in distortion or discontinuity of the stitched portion, and thereby an unnatural omnidirectional image is produced.

Thus, the camera body 1 in this embodiment has a function as a contrast detector that detects a contrast of each partial image, and the camera of this embodiment determines a high contrast area (first area) including the skyscrapers 30 whose contrast is high and a low contrast area (second area) including the ground 32, the sky 33 and others whose contrasts are low. Furthermore, the camera performs the optical zoom operations of the lens barrels 2G and 2H to produce partial images in which the stitched portions SG and SH are included in the low contrast area. Simultaneously, the camera performs the optical zoom operations of the other lens barrels 2A to 2F to compensate for changes of the field angles of the lens barrels 2G and 2H. Specifically, the camera performs the telephoto-side optical zoom operations of the lens barrels (first magnification-variable optical systems) 2G and 2H and performs the wide-angle-side optical zoom operations of the lens barrels (second magnification-variable optical systems) 2A to 2F. This moves the stitched portions (joined portions) SG and SH denoted by the broken lines to stitched portions SG′ and SH′ denoted by solid lines.

Such an optical zoom process enables reducing a possibility that the unnatural omnidirectional image including the distortion or discontinuity of the stitched portion is produced.

The partial images in which the stitched portion is included in the low contrast area may be newly acquired after the determination of the contrast, and such partial images may be extracted from the multiple partial images acquired during the optical zoom operations.

FIG. 16 illustrates an omnidirectional image acquirable when, as illustrated in FIGS. 13A and 13B, the camera performs the telephoto-side optical zoom operation of the lens barrel 2A and the wide-angle-side optical zoom operations of the lens barrels 2B, 2F, 2G and 2H. Magnification-variable optical systems include ones each whose brightness (F-number) changes in response to its variation of magnification.

Specifically, the brightness becomes dark (the F-number increases) with telephoto-side variation of magnification. Description will below be made of brightness correction when such a lens barrel whose brightness changes in response to its variation of magnification is used.

In FIG. 16, a partial image ImgA is acquired through the lens barrel 2A in a further telephoto-side magnification state (further telephoto-side zoom magnification ratio) than those of the lens barrels 2C to 2E. Partial images ImgB, ImgF, ImgG and ImgH are acquired respectively through the lens barrels 2B, 2F, 2G and 2H in further wide-angle-side magnification states than those of the lens barrels 2C to 2E. The partial image ImgA is darker than partial images ImgC to ImgE acquired through the lens barrels 2C to 2E, and the partial images ImgB, ImgF, ImgG and ImgH are brighter than the partial images ImgC to ImgE.

The field angles of the lens barrels 2 are originally mutually different due to the numbers thereof in the horizontal plane and in the vertical plane, and the F-numbers of the respective lens barrels 2 are also mutually different due to differences of the magnification ratios thereof, so that the partial images respectively acquired through the lens barrels 2 have differences in brightness. Therefore, the stitched portions in the omnidirectional image have brightness differences. Thus, the camera body 1 in this embodiment has a function as a brightness corrector. This brightness correction function converts a difference between predetermined F-numbers corresponding to the magnification ratios into a brightness step number, and performs brightness correction (brightness control) on the partial image using the step number. The brightness correction may be performed so as to match the brightness to those of, among the eight lens barrels 2, ones whose optical conditions including the F-numbers are mutually identical and whose number is greatest, or may be performed as predetermined by a user. Most omnidirectional images include in somewhere a high intensity object such as the sun or an illumination, and therefore have uneven brightness, so that it is necessary to perform, on such omnidirectional images, brightness correction depending on image-capturing environment. Performing in the camera body 1 the above-described brightness correction for correcting the difference in F-number corresponding to the difference in zoom magnification ratio before the brightness correction depending on the image-capturing environment enables finally providing a natural omnidirectional image in which the stitched portions have little difference in brightness.

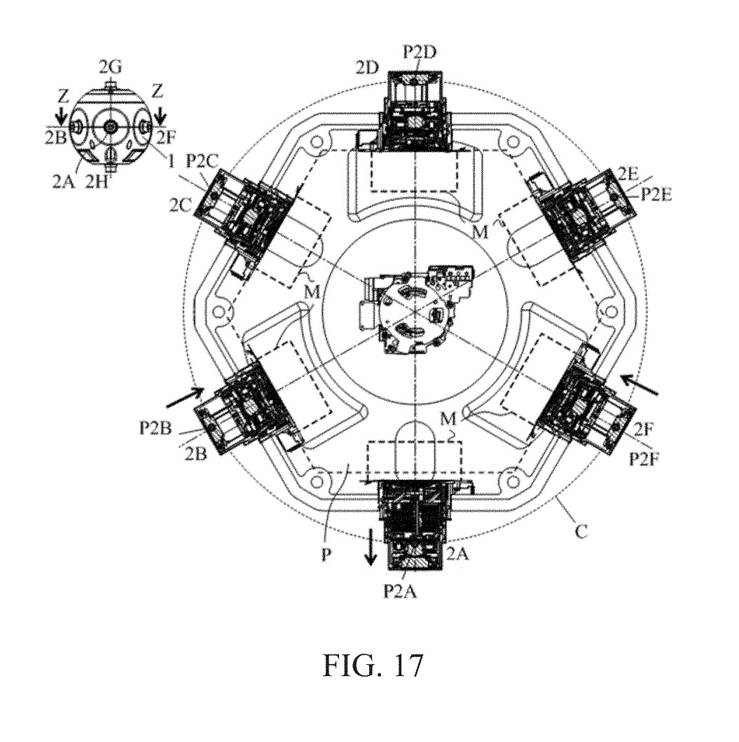

FIG. 17 illustrates a section of the camera body 1 cut along a plane Z and corresponding to when, as illustrated in FIG. 13A, the lens barrel 2A performs the further telephoto-side optical zoom operation than the lens barrels 2C to 2E and the lens barrels 2B and 2F perform the further wide-angle-side optical zoom operations than the lens barrels 2C to 2E. In FIG. 17, the spherical external member of the camera body 1 is omitted.

Typically, an entrance pupil position (hereinafter referred to as “a nodal point”) of a magnification-variable optical system is located at a vicinity of a most-object side lens unit (a first lens unit LS1 in this embodiment), and moves to an image-capturing surface side with a telephoto-side optical zoom operation of the magnification-variable optical system narrowing its field angle. When a panorama image or an omnidirectional image is produced by joining together multiple partial images acquired through multiple lens barrels, it is desirable to arrange the multiple lens barrels such that their nodal points are located as mutually close as possible to reduce parallaxes between the partial images.

This makes it possible to smoothly join the partial images together. This embodiment cannot arrange the lens barrels 2A to 2F such that their nodal points are located at an identical position. However, as an alternative method, this embodiment arranges the lens barrels 2A to 2F such that their nodal points P2A to P2F are located on an identical circle.

The camera body 1 includes thereinside moving mechanisms M that move the respective lens barrels 2 (2A to 2F) in their optical axis directions each using a drive actuator (not illustrated) separate from the drive motor 29. The camera detects positions of the lens barrels 2 in the optical axis direction using position sensors (not illustrated), detects the zoom magnification ratios (zoom positions) thereof, and controls the moving mechanisms M such that the nodal points are located on a predetermined identical circle C regardless of changes of the zoom positions. The positions of the nodal point are optically defined depending on the zoom positions, so that it is desirable to store the positions of the nodal point corresponding to the respective zoom positions as difference amounts from a predetermined reference position (for example, a position in the wide-angle state) to a memory (not illustrated). Thereby, the camera can move the lens barrel 2 by the moving mechanism M so as to cancel out the difference amount corresponding to the detected zoom position.

In FIG. 17, the camera moves, with reference to positions P of the lens barrels 2C to 2E, the entire lens barrel 2A performing the telephoto-side optical zoom operation to the object side by its moving mechanism M, and moves the entire lens barrels 2B and 2F performing the wide-angle-side optical zoom operations to the image-capturing surface side by their moving mechanisms M. This enables, even though the lens barrels 2A to 2F are set to mutually different zoom positions, disposing the nodal points P2A to P2F of the lens barrels 2A to 2F on the identical circle C, and thereby enables making the parallaxes between the partial images acquired through the lens barrels 2A to 2F approximately identical to one another. Therefore, the camera can produce an omnidirectional image in which the multiple partial images are joined together without unnaturalness.

The identical circle C on which the nodal points P2A to P2F of the lens barrels 2A to 2F should be located means a circle having a certain width in its diameter direction. The certain width corresponds to an allowable range for differences of the nodal points, where the differences generate parallaxes of the partial images acquired through the lens barrels 2A to 2F, the parallaxes being no problem in joining these partial images.

Although FIG. 17 described the case of controlling the moving mechanisms M such that the nodal points of the lens barrels 2A to 2F arranged in the horizontal plane, similar control can apply to the moving mechanisms M for the lens barrels 2G, 2H, 2A and 2D arranged in the vertical plane illustrated in FIG. 13B.

A configuration may be employed in which multiple lens barrels are arranged such that their optical paths mutually intersect, and the lens barrels are moved such that movements of their nodal points due to changes of their zoom positions are canceled out.

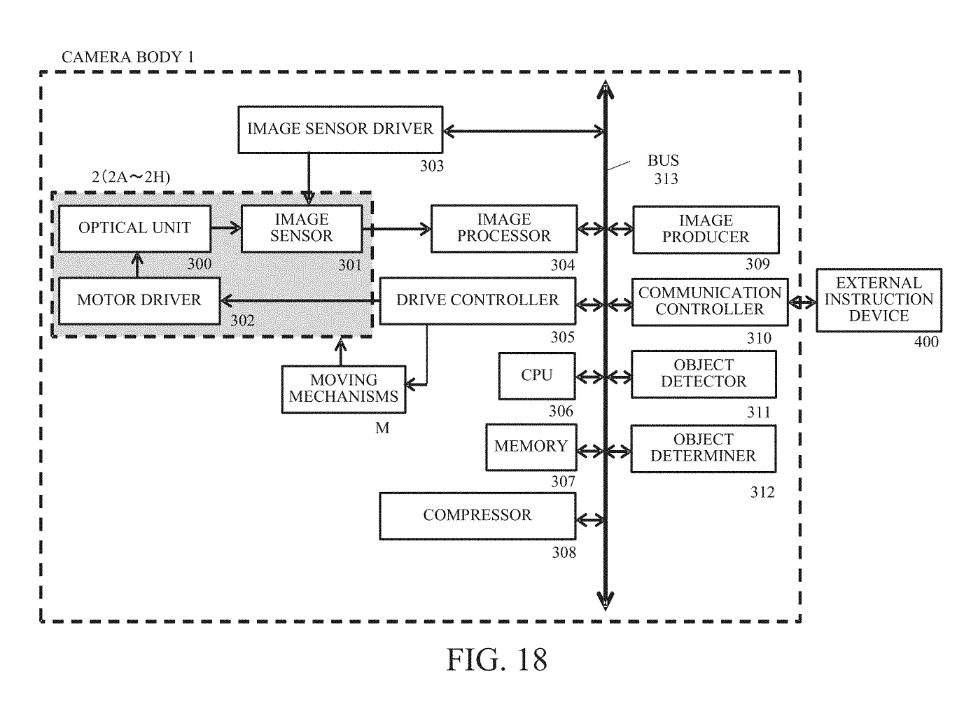

FIG. 18 illustrates a system configuration of the camera body 1. Each of the lens barrels 2 (2A to 2H) includes an optical unit 300 (first to third lens holding barrels 21, 23 and 26), an image sensor 301 and a motor driver 302 including the drive motor 29.

The optical unit 300 is moved in the optical axis direction by the motor driver 302. A movement amount of the optical unit 300 by the motor driver 302 is transmitted as a control signal from a CPU 306 as a main controller to the motor driver 302 through a drive controller 305. In addition, each lens barrel 2 is provided with the moving mechanism M illustrated in FIG. 17.

An object image formed by the optical unit 300 is converted into an electronic signal by the image sensor 301 driven by an image sensor driver 303. The CPU 306 controls the drive of the image sensor 301 through the image sensor driver 303.

An image processor 304 as an image producer performs A/D conversion of analog image-capturing signals output from the image sensors 301 of the respective lens barrels 2, and performs, on partial images as A/D converted digital image-capturing signals, the brightness correction depending on the F-numbers corresponding to the zoom positions of the respective lens barrels 2. The image processor 304 serves as the brightness corrector. Furthermore, the image processor 304 performs, on the partial images acquired through the respective lens barrels 2, image processes such as tone correction and white balance. The lens barrels 2 (2A to 2H), the image sensors 301 provided in the lens barrels 2 and the image processor 304 constitute an image-capturing device.

An image producer 309 performs the stitching process on the partial images produced through the eight lens barrels 2 by the image processor 304 to produce an omnidirectional image. The image producer 309 serving as a contrast detector detects the contrasts of the respective partial images, and determines the high contrast area and the low contrast area in each of the partial images. The CPU 306 causes the lens barrels 2, depending on a result of the determination, to perform the optical zoom operations necessary for causing the low contrast areas to include the stitching portions of the partial images. A memory 307 is constituted by a volatile or non-volatile memory. The memory 307 temporarily stores image capturing data of the partial images and the omnidirectional images and stores processing programs to be executed by the CPU 306. A compressor 308 compresses and encodes the image-capturing data according to an encoding method such as JPEG. A communication controller 310 transmits the compressed and encoded image-capturing data to external devices (not illustrated).

The image producer 309 performing the stitching process to produce the omnidirectional image is not necessarily to be provided in the camera. That is, a configuration may be employed that the camera sends the image-capturing data of the partial images through the communication controller 310 to an external image producing device (not illustrated) such as a personal computer and that the external image producing device produces the omnidirectional image.

An object detector 311 and an object determiner 312 recognize a specific object to be enlarged in the omnidirectional image, and determine the lens barrel 2 through which the specific object is captured. The CPU 306 causes, depending on a result of the above determination, the lens barrel (specific lens barrel) 2 through which the specific object is captured to perform a telephoto-side optical zoom operation, and causes the lens barrels 2 adjacent to the specific lens barrel 2 to perform wide-angle-side optical zoom operations.

The CPU 306 receives, through wired or wireless communication through the communication controller 310, input of a command that instructs the telephoto-side optical zoom operation of the specific lens barrel 2 from an external instruction device 400 such as a personal computer or a smartphone. The CPU 306 causes, in response to the command, the specific lens barrel 2 to perform the telephoto-side optical zoom operation, and causes the lens barrels 2 adjacent to the specific lens barrels 2 to perform the wide-angle-side optical zoom operations. Thereby, an omnidirectional image-capturing system including the omnidirectional camera and the external instruction device 400 is constituted.

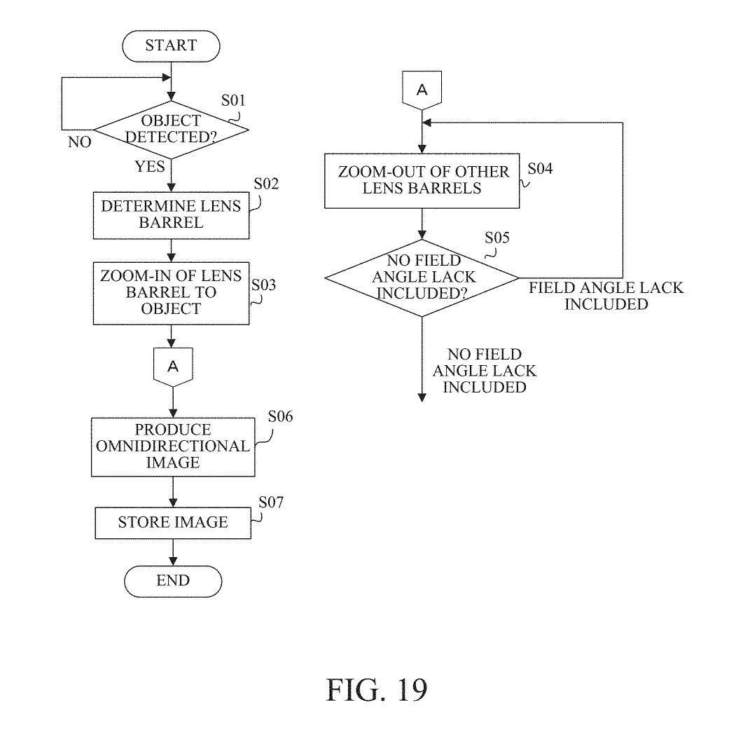

FIG. 19 illustrates a flowchart of an image-capturing control process performed for acquiring the enlarged image of the specific object P described with reference to FIGS. 13A and 13B. The CPU 306 as a computer executes the image-capturing control process according to an image-capturing program as a computer program.

At step S01, the CPU 306 performs omnidirectional image capturing to acquire an omnidirectional image. Then, the CPU 306 determines whether or not the object detector 311 has detected the specific object P such as a person from the omnidirectional image. If the object detector 311 has not detected the specific object P, the CPU 306 repeats the determination at step S01. If the object detector 311 has detected the specific object P, the CPU 306 proceeds to step S02 to cause the object determiner 312 to determine, of the eight lens barrels 2 (2A to 2H), the lens barrel 2 (hereinafter, the lens barrel 2A) capturing the detected specific object P. An example of the specific object P is an object satisfying a predetermined detection condition and is automatically detected from the omnidirectional image.

Next at step S03, the CPU 306 causes, through the drive controller 305, the lens barrel 2A to perform a telephoto-side optical zoom (zoom-in) operation.

The CPU 306 causes the lens barrel 2A to perform the zoom-in operation such that the specific object P is captured as large as possible in the field angle of the lens barrel 2A. Furthermore, at step S04, the CPU 306 causes the lens barrels 2B, 2F, 2G and 2H adjacent to the lens barrel 2A through the drive controller 305 to perform wide-angle-side optical zoom (zoom-out) operations. Thereby, the narrowed field angle of the lens barrel 2A having performed the zoom-in operation is compensated for. The CPU 306 calculates zoom-out amounts of the lens barrels 2B, 2F, 2G and 2H so as to satisfy the above-described omnidirectional image-capturing closest distance L2. Moreover, at steps S03 and S04, the CPU 306 controls, with the optical zoom operations of the lens barrels 2A, 2B, 2F, 2G and 2H, the moving mechanisms M provided for these lens barrels 2A, 2B, 2F, 2G and 2H such that their nodal points are located on the identical circle.

Next at step S05, the CPU 306 determines whether or not an omnidirectional image including no field angle lack is acquirable. The field angle lack is generated when the lens barrels 2B, 2F, 2G and 2H cannot perform optical zoom operations satisfying the omnidirectional image-capturing closest distance L2 or when the field angles of the lens barrels 2B, 2F, 2G and 2H do not overlap part of the field angle of the lens barrel 2A at the infinite distance.

If the acquirable omnidirectional image includes the field angle lack, the CPU 306 returns to step S04 to cause the lens barrels 2B, 2F, 2G and 2H to further perform the zoom-out operations, and repeats this step until an omnidirectional image including no field angle lack is acquired. On the other hand, if acquirable omnidirectional image includes no field angle lack, the CPU 306 proceeds to step S06. At step S06, the CPU 306 causes the image producer 309 to perform the stitching process of the eight partial images produced by the image processor 304 to produce an omnidirectional image. Then, at step S07, the CPU 306 stores the omnidirectional image to the memory 307, and ends this process.

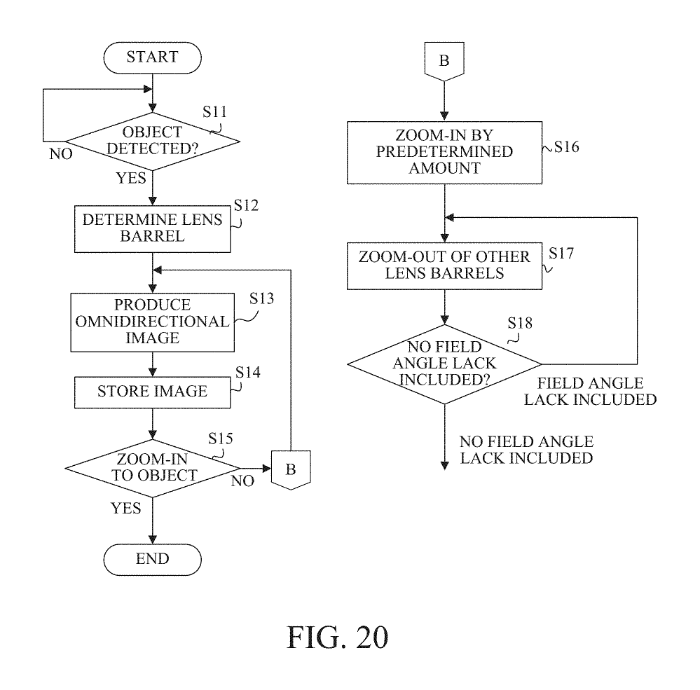

FIG. 20 illustrates a flowchart of an image-capturing control process performed for acquiring the enlarged images of the specific object P during the optical zoom operation described with reference to FIG. 16. The CPU 306 as the computer executes the image-capturing control process according to the above-described image-capturing program. Steps S11 and S12 are identical to steps S01 and S02 illustrated in FIG. 19. Also in the following description, the lens barrel 2A has been determined as the lens barrel 2 capturing the specific object P. Next at step S13, the CPU 306 causes the image producer 309 to perform the stitching process on eight partial images produced by the image processor 304 to produce an omnidirectional image. Then, at step S14, the CPU 306 stores the omnidirectional image to the memory 307.

Next at step S15, the CPU 306 determines whether or not the lens barrel 2A has performed a zoom-in operation by which the specific object P is captured as large as possible in the field angle of the lens barrel 2A. If the lens barrel 2A has performed the zoom-in operation, the CPU 306 ends this process. On the other hand, if the lens barrel 2A has not performed the zoom-in operation, the CPU 306 proceeds to step S16. At step S16, the CPU 306 causes, through the drive controller 305, the lens barrel 2A to perform the zoom-in operation by a zoom amount predetermined by a user. This zoom amount is set to an enlargement pitch of multiple enlarged images sequentially acquired during the optical zoom operation to the TELE position. Setting a finer enlargement pitch smoothly enlarges the specific object P when the enlarged images of the specific object P are displayed on the monitor from a state where the omnidirectional image is displayed.

Furthermore, the CPU 306 causes, in response to each zoom-in operation of the lens barrel 2A, the lens barrels (circumjacent lens barrels) 2B, 2F, 2G and 2H adjacent to the lens barrel 2A to perform the zoom-out operations through the drive controller 305. Thereby, the narrowed field angle of the lens barrel 2A having performed the zoom-in operation is compensated for. The CPU 306 calculates zoom-out amounts of the lens barrels 2B, 2F, 2G and 2H so as to satisfy the above-described omnidirectional image-capturing closest distance L2.

Step S18 is identical to step S05 illustrated in FIG. 19. If the acquirable omnidirectional image includes the field angle lack, the CPU 306 returns to step S17 to cause the lens barrels 2B, 2F, 2G and 2H to further perform the zoom-out operations, and repeats this step until an omnidirectional image including no field angle lack is acquired. On the other hand, if the acquirable omnidirectional image includes no field angle lack, the CPU 306 returns to step S13 to produce an omnidirectional image and store it at step S14.

This embodiment described the case where, as an example, each lens barrel has three-lens magnification-variable optical system including the three lens units. However, as other examples, other magnification-variable optical systems than the three-lens magnification-variable optical system may be used.

The embodiment described above enables simultaneously providing, by using a single camera, a wide-field image and a high-quality enlarged image of an object included in the wide-field image.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-066488, filed on Mar. 30, 2017, which is hereby incorporated by reference herein in its entirety.

What is claimed is:

1. An image-capturing apparatus comprising:
an image-capturing device configured to perform image capturing through multiple magnification-variable optical systems to acquire multiple images to be continuously joined together; and
a controller configured to control magnification-varying operations of the respective magnification-variable optical systems,
wherein the controller is configured to, when a first magnification-variable optical system of the multiple magnification-variable optical systems performs the magnification-varying operation to a telephoto side, cause a second magnification-variable optical system thereof to perform the magnification-varying operation to a wide-angle side.

2. An image-capturing apparatus according to claim 1, wherein the first and second magnification-varying optical systems are used for acquiring at least two images to be joined together.

3. An image-capturing apparatus according to claim 1, wherein the image-capturing device is configured to perform image capturing through at least the first and second magnification-varying optical systems of the multiple magnification-varying optical systems during the magnification-varying operations of the first and second magnification-varying optical systems.

4. An image-capturing apparatus according to claim 1, further comprising a contrast detector configured to detect contrasts of the respective multiple images,
wherein the controller is configured to, when in each of two images to be joined together among the multiple images a first area of a high contrast and a second area of a lower contrast than that of the first area are detected, cause the first and second magnification-variable optical systems to perform the magnification-varying operations so as to form the second areas of the two images as areas to be joined together.

5. An image-capturing apparatus according to claim 1, further comprising a brightness corrector configured to control brightnesses of the multiple images, depending on F-numbers corresponding to magnification-varying states of the multiple magnification-variable optical systems.

6. An image-capturing apparatus according to claim 1, further comprising moving mechanisms configured to move the respective multiple magnification-variable optical systems in their optical axis directions,
wherein the controller is configured to control the moving mechanisms in response to the magnification-varying operations of the first and second magnification-variable optical systems such that entrance pupils of the multiple magnification-variable optical systems are located on an identical circle.

7. An image-capturing apparatus according to claim 1, wherein the controller is configured to control the magnification-varying operations of the multiple magnification-variable optical systems to set field angles of the respective magnification-variable optical systems to ones corresponding to minimum image-capturing distances at which the field angles have no discontinuity therebetween.

8. An image-capturing apparatus according to claim 1, wherein the following condition is satisfied:
θ<θ₁/2+θ₂/2
where θ represents an angle formed between optical axes of the first and second magnification-variable optical systems, and θ₁ and θ₂ respectively represent field angles of the first and second magnification-variable optical systems.

9. An image-capturing apparatus according to claim 1, further comprising an image producer configured to join the multiple images together to produce a joined image.

10. An image-capturing control method comprising:
a step of performing image capturing through multiple magnification-variable optical systems to acquire multiple images to be continuously joined together; and
a control step of controlling magnification-varying operations of the respective magnification-variable optical systems,
wherein the control step causes, when a first magnification-variable optical system of the multiple magnification-variable optical systems performs the magnification-varying operation to a telephoto side, a second magnification-variable optical system thereof to perform the magnification-varying operation to a wide-angle side.

11. A non-transitory storage medium storing a computer program that causes a computer in an image-capturing apparatus, which is configured to perform image capturing through multiple magnification-variable optical systems to acquire multiple images to be continuously joined together, to perform a control process for controlling the image-capturing apparatus, the process comprising:
a control step of controlling magnification-varying operations of the respective magnification-variable optical systems,
wherein in the control step the process causes, when a first magnification-variable optical system of the multiple magnification-variable optical systems performs the magnification-varying operation to a telephoto side, a second magnification-variable optical system thereof to perform the magnification-varying operation to a wide-angle side.

12. An image-capturing apparatus comprising:
a main body of the apparatus;
multiple image-capturing devices provided in the main body such that their optical axes mutually intersect at one point and each configured to be capable of performing an optical zoom operation; and
a controller configured to control the optical zoom operations of the image-capturing devices,
wherein:
the image-capturing devices are configured to perform image capturing for acquiring an omnidirectional image by partially overlapping their field angles; and
the controller is configured to, when a first image-capturing device of the multiple image-capturing devices performs image capturing with the optical zoom operation to a telephoto side for acquiring an enlarged image of a specific object, cause a second image-capturing device of the multiple image-capturing devices to perform the optical zoom operation to a wide-angle side so as to generate no field angle lack between the first and second image-capturing devices, thereby maintaining the image capturing for acquiring the omnidirectional image by the multiple image-capturing devices.

13. An image-capturing apparatus according to claim 12, wherein the multiple image-capturing devices are configured to continuously perform image capturing during the optical zoom operations of the first and second image-capturing devices controlled by the controller.

14. An image-capturing apparatus according to claim 12, further comprising an image producer configured to join together the multiple images acquired by the multiple image-capturing devices including the first and second image-capturing devices to acquire the omnidirectional image, and to produce the enlarged image of the specific object.

15. An image-capturing apparatus according to claim 14, further comprising an image processor configured to control brightnesses of the multiple images depending on F-numbers corresponding to optical zoom states of the multiple image-capturing devices, and
wherein the image producer is configured to join together the multiple images having the controlled brightnesses to produce the omnidirectional image.

16. An image-capturing apparatus according to claim 12, further comprising moving mechanisms configured to move the respective multiple image-capturing devices in their optical axis directions,
wherein the controller is configured to control the moving mechanisms in response to the optical zoom operations of the first and second image-capturing devices such that entrance pupils of the multiple image-capturing devices are located on an identical circle.

17. An image-capturing apparatus according to claim 12, wherein the multiple image-capturing devices are provided at equal intervals around the main body.

18. An image-capturing apparatus according to claim 12, wherein the controller is configured to cause the first and second image-capturing devices to simultaneously perform their optical zoom operations.
